(19) United States
(12) Patent Application Publication
(10) Pub. No.: US 2005/0237861 A1
(43) Pub. Date: Oct. 27, 2005

(54) Quantitative display apparatus

(76) Inventor: Earl S. Bell, Brooklyn, NY (US)

Correspondence Address: BRIAN ROFFE, ESQ, 11 SUNRISE PLAZA, SUITE 303, VALLEY STREAM, NY, 11580-6170, US

(21) Appl. No.: 11/111,472

(22) Filed: Apr. 21, 2005

Related U.S. Application Data
(60) Provisional application No. 60/564,491, filed on Apr. 23, 2004.

(51) Int. Cl. G04C 17/00

(52) U.S. Cl. 368/223

(57) ABSTRACT

Display apparatus including an annular frame defining a central region, at least one set of indications arranged on the frame around the central region, at least one projection arranged proximate, in correspondence with or in alignment with one set of indications, and a rotation mechanism coupled to a connection point on each projection to rotate the projection such that the connection point is rotated in a loop around the central region. The rotation mechanism determines a quantity to be displayed and control rotation of the projection(s) based thereon. The projections can extend inward from rotatable rings (and not outward from a common, central point or area) so that the central region defined by the frame may be open. When multiple rings are used in connection with the same set of indications, the projections on the rings are different in form, size, color and/or shape.

### CROSS REFERENCE TO RELATED APPLICATION

This application claims priority under 35 U.S.C. §119(e) of U.S. provisional patent application Ser. No. 60/564,491 filed Apr. 23, 2004, the specification of which is incorporated by reference herein.

### FIELD OF THE INVENTION

The present invention relates generally to a quantitative display apparatus for displaying one or more quantities, and in particular to a display apparatus which is capable of measuring and displaying one or more physical quantities.

### BACKGROUND OF THE INVENTION

Display apparatus which display physical quantities take various forms. One fairly common form is a circular watch which displays time, including the hour, minutes and seconds. The typical watch includes a circular face with indications along its periphery, a large minute hand which rotates over the face and about a central point on the face, and a smaller hour hand which rotates about the same central point on the face as the minute hand. A timing and rotation mechanism is located below the face to rotate the minute and hour hands at appropriate times via rotatable pins connected thereto. A setting knob is connected to the timing mechanism to enable the minute and hour hands to be set to point to the correct indications. When provided, a seconds hand is arranged to rotate about a different point on the face of the watch to point to a different set of indications.

One disadvantage of the typical circular watch is that the timing and rotation mechanism is somewhat complicated as it must be constructed to enable substantially simultaneous rotation of two pins about the same axis. Another disadvantage is that the minute and hour hands invariably overlap at some point during their respective rotations about the central point on the face which reduces the ability to readily determine the time.

It would be desirable to provide a display apparatus which is capable of displaying time as well as any other physical quantities in an easy to read format.

### OBJECTS AND SUMMARY OF THE INVENTION

Accordingly, it is an object of the present invention to provide a new and improved display apparatus.

It is another object of the present invention to provide a new and improved display apparatus which does not include any hands that extend from and rotate about a common point on a face of the apparatus.

It is yet another object of the present invention to provide a new and improved display apparatus which is capable of providing a direct and rapid reading of information displayed thereon.

It is still another object of the present invention to provide a new and improved display apparatus which has a central void which can be used to store objects, for ornamental purposes or for housing a device which provides a functional aspect, such as a memory device.

In order to achieve these objects and others, a display apparatus in accordance with the invention includes a frame defining a central region, at least one set of indications arranged on the frame around the central region, at least one projection arranged proximate, in correspondence with or in alignment with one set of indications, and a rotation mechanism coupled to a connection point on each projection to rotate the projection such that the connection point is rotated in a loop around the central region. Specifically, each projection may revolve around a central axis of the frame. The rotation mechanism determines a quantity to be displayed and controls rotation of the projection(s) based thereon.

Each projection may extend from a respective ring, e.g., radially inward, radially outward, upward or downward, and which rings are mounted to the frame. In this case, the connection point on each projection is a point at which the projection is connected to the respective ring. The ring(s) can be rotatable relative to the frame such that rotation of the ring(s) causes rotation of the projection(s) in the loop around the central region of the frame, e.g., revolutions of the projections(s) about the central axis of the frame. When multiple projections are provided, they are preferably different in size, shape and/or form.

When the projections extend from the rings (and not outward from a common, central point or area), a central region or passage defined by the frame may be open since it is not used to house the rotation mechanism. Rather, the rotation mechanism may be partially or fully housed in an annular chamber defined on a lower side of the frame and which is enclosed by a cover.

The frame may be annular, i.e., have a substantially circular cross section and shaped like a ring, or may have any other cross-sectional shapes so long as the projections can be coupled to the rotation mechanism about connection points can be rotated in loops about the central region of the frame. That is, the projections do not rotate about a common central axis of the frame as in conventional watches. An open passage in a central region of the frame can therefore extend significantly into and preferably entirely through the axial thickness of the apparatus.

When multiple rings are used in connection with the same set of indications, the projections on the rings are preferably different in form, size and/or shape. If the same projections are provided on different rings, then the apparatus can be constructed such that each projection is associated with a respective set of indications.

The rings may be positioned in grooves formed on a cylindrical, inner facing face of the frame with the projections extending outward from the grooves. The rotation mechanism would then include drive devices which extend into a respective groove and/or cooperate with the respective ring to cause rotate when directed by a processing unit of the rotation mechanism.

The rings may be enclosed within a chamber defined by the inner facing face of the frame and an inner rim coupled to the frame. The inner rim may be transparent to enable visualization of the set of indications and the projections on the rings. The inner rim may also define an open central area or passage which may remain open or in which objects may be placed, e.g., a housing including display for displaying a physical quantity in a different form than displayed by cooperation of the projections and set(s) of indications. The housing could also include or be replaced by any type of mechanism electrical, chemical or organic attachment. Alternatively, the inner rim can be replaced by upper and lower covers engaging with the frame to enclose the rings in a chamber defined by the covers and the frame. At least the upper cover, or a part thereof, would be transparent to enable visualization of the rings. In this construction, there would not be any void in the center of the apparatus.

Another embodiment of a display apparatus in accordance with the invention includes a frame defining an open passage and a central axis, at least one set of indications arranged on the frame, at least one ring mounted on the frame to rotate about the central axis of the frame, each ring including an inwardly directed projection arranged proximate, in correspondence with or in alignment with a set of indications, and a rotation mechanism coupled to each ring to rotate it. Each projection originates from a respective ring and can point in any direction to be proximate, in correspondence with or in alignment with the indications. Thus, the projections can be directed radially inward toward the central axis or toward any other direction, e.g., upward or downward such as if used as a landscape piece. Indeed, it is possible to space the rings from the circumferential edge of the apparatus and place the indications between the outermost ring and the circumferential edge of the apparatus in which case, the projections could be directed outward from the rings, e.g., radially outward.

Another embodiment of a display apparatus in accordance with the invention includes a frame defining an interior space, a screen arranged in the interior space, and a measuring and display system arranged in connection with the frame and coupled to the screen for determining at least one physical quantity to be displayed on the screen. The measuring and display system directs or controls the screen to display a set of indications in a fixed position relating to each physical quantity and at least one projection which is caused to move relative to the indications as each physical quantity changes. For use as a time piece, the screen may be annular, the indications may be numbers and there are two or three projections, e.g., an hour projection, a minute projection and a possible seconds projections.

### BRIEF DESCRIPTION OF THE DRAWINGS

The following drawings are illustrative of embodiments of the invention and are not meant to limit the scope of the invention as encompassed by the claims.

FIG. 1 is a top view of a first embodiment of a display apparatus in accordance with the invention.

FIG. 2 is an enlarged view of the section designated 2 in FIG. 1.

FIG. 3 is a cross-sectional view of the display apparatus shown in FIG. 1 taken along the line 3-3.

FIG. 4 is an enlarged view of the section designated 4in FIG. 3.

FIG. 5 is a perspective view with parts removed of the display apparatus shown in FIG. 1

FIG. 6 is an exploded view of the display apparatus shown in FIG. 1 with parts removed.

FIG. 7 is a cross-sectional, partially exploded view of a second embodiment of a display apparatus in accordance with the invention.

FIG. 8 is a top view of a third embodiment of a display apparatus in accordance with the invention.

### DETAILED DESCRIPTION OF THE INVENTION

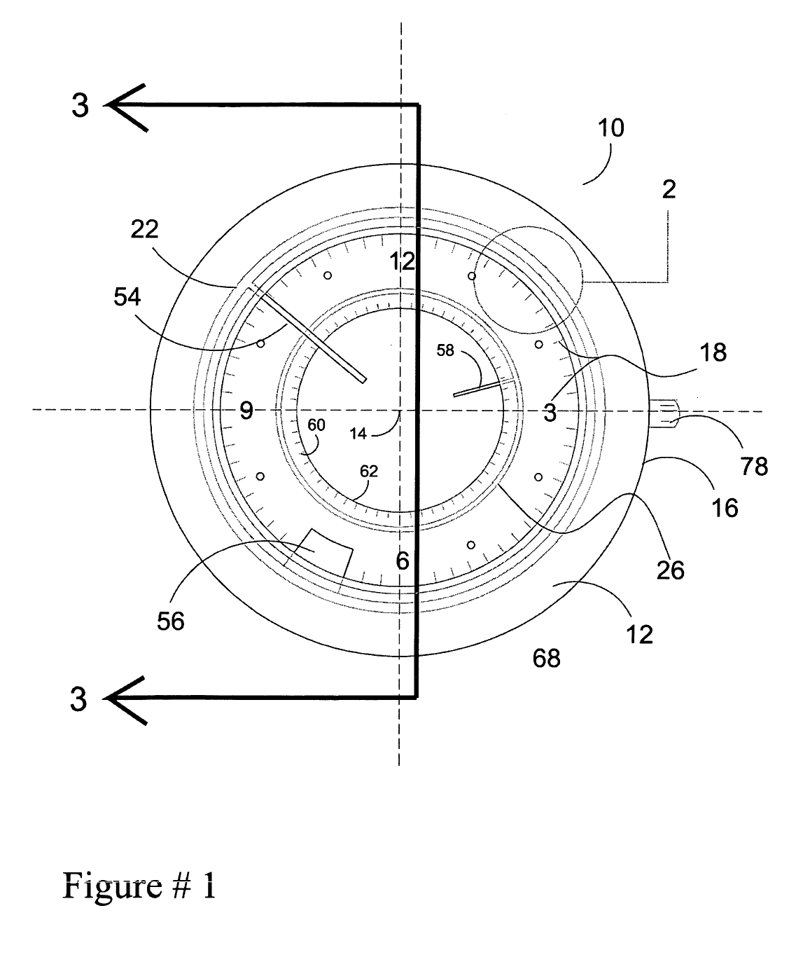

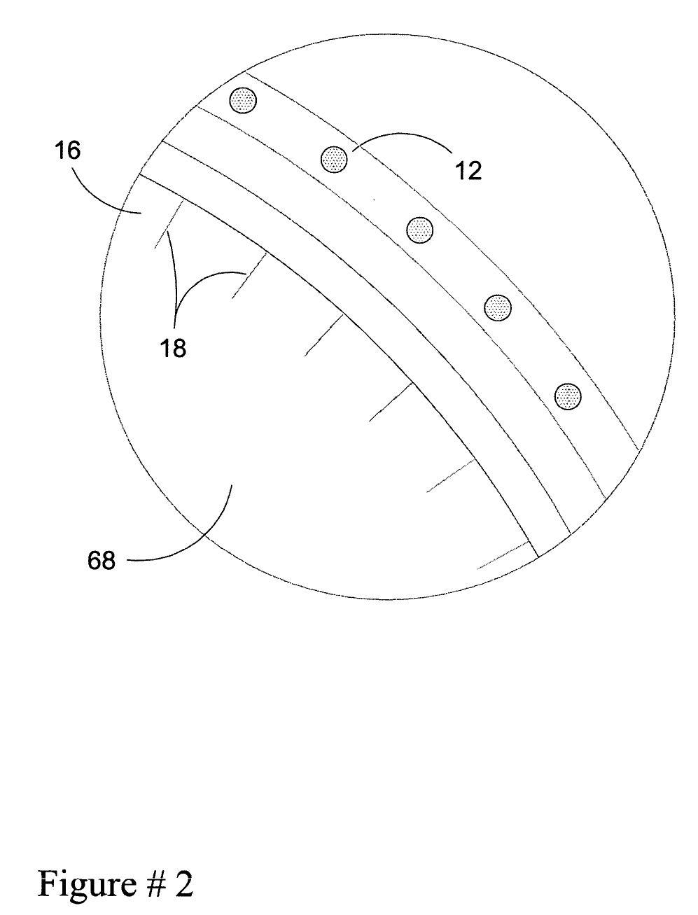

Referring to the accompanying drawings wherein like reference numerals refer to the same or similar elements, FIG. 1 shows a display apparatus in accordance with the invention which is designated generally as 10 and includes an annular frame 12 defining a central axis 14, a first set 16 of indications 18 arranged on an upward facing surface of the frame 12, three rings 22, 24, 26 mounted on the frame 12 to rotate about the central axis 14, and a rotation mechanism 28 coupled to each ring 22, 24, 26 to rotate them.

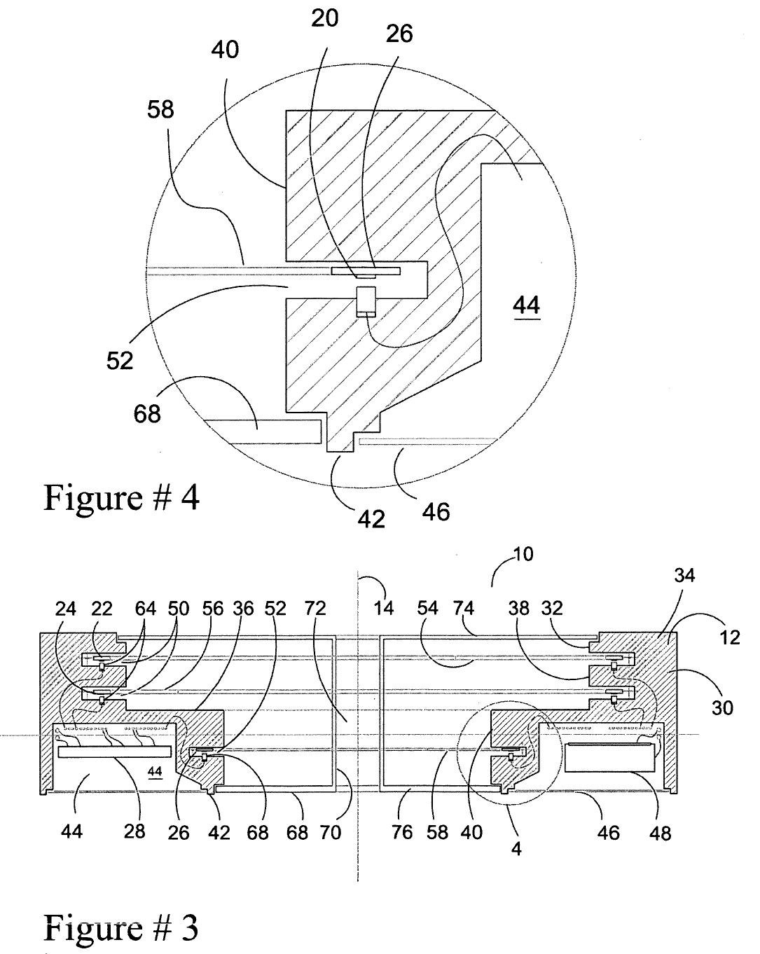

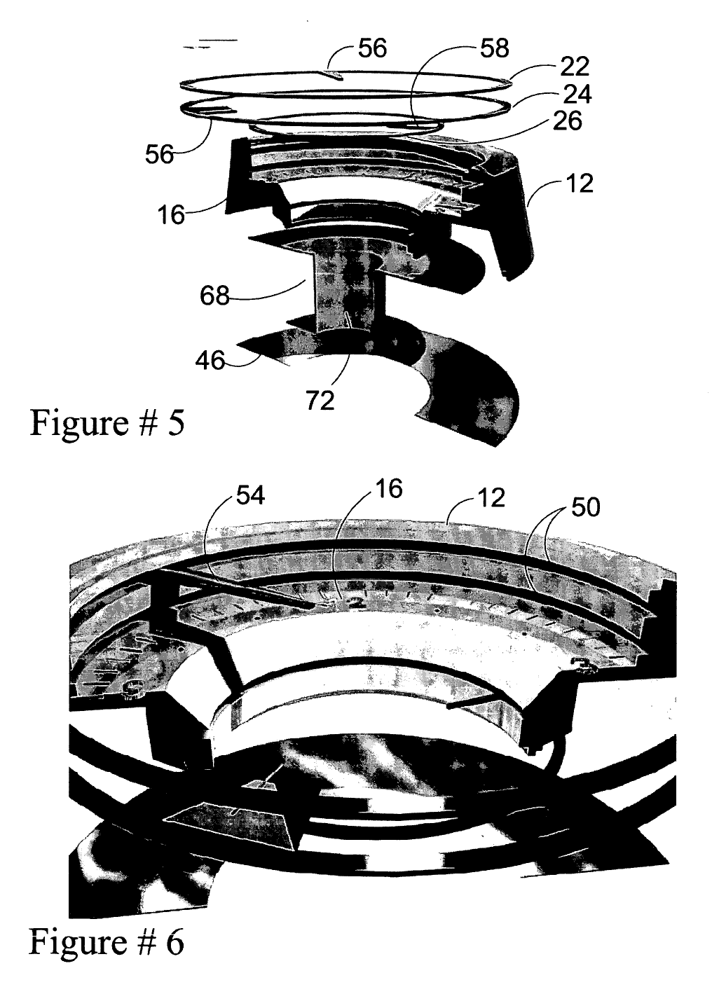

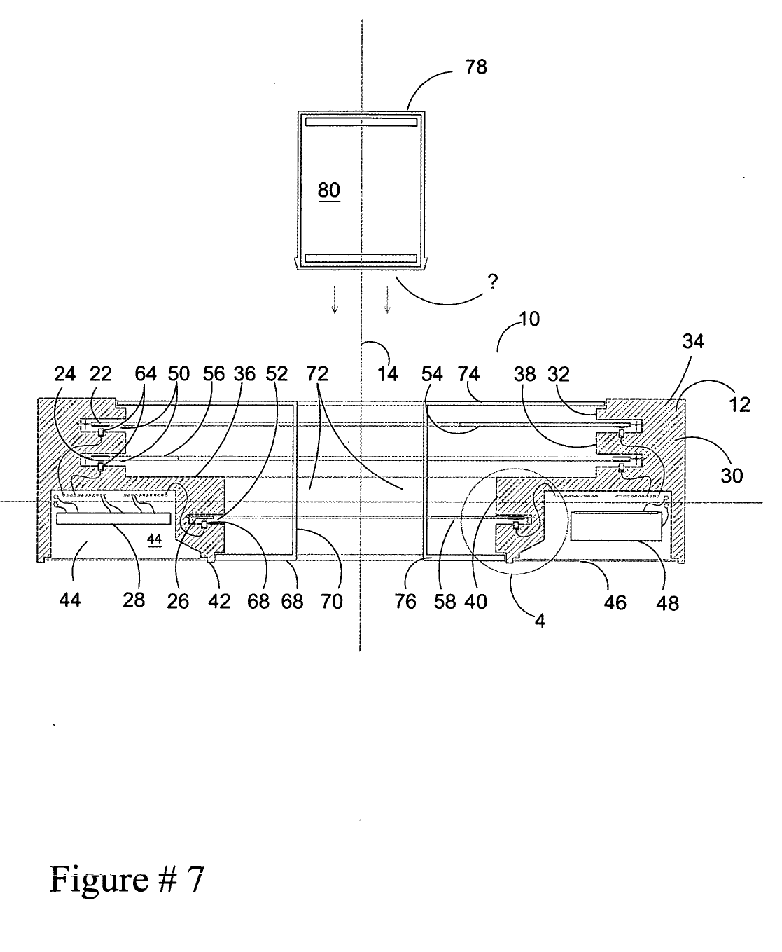

Frame 12 includes a substantially cylindrical outer face 30, a substantially cylindrical inner face 32 facing the central axis 14, an upwardly facing outer face 34 and an upwardly facing intermediate face 36 on which the set 16 of indications 18 is formed (see FIG. 3). The inner face 32 includes a first face portion 38 situated between the outer face 34 and the intermediate face 20 and a second face portion 40 situated between the intermediate face 36 and a lower face 42 of the frame 12. The frame 12 defines an annular chamber 44 on a lower side opening into the lower face 42. The rotation mechanism 28 is at least partially arranged in the chamber 44 (see FIG. 3).

Although in the illustrated embodiment, the indications 18 are arranged on the intermediate face 36 of the frame 12, they may be formed as a separate unit from the frame 12 and attached thereto.

A cover 46, or bottom ringed lid, is removably or fixedly connected to the frame 12 to enclose the annular chamber 44. In either case, cover 46 may include a removable section which aligns with a power source such as a removable battery 48 housed in the annular chamber 44 and which powers the rotation mechanism 26 in order to enable the battery 48 to be replaced when necessary. Cover 46 may be contiguous with the lower face 42 of the frame 12 and hermetically sealed to the frame 12 to prevent the intrusion of liquids and particulate matter into the chamber 44 which might adversely affect the operation of the rotation mechanism 28.

The frame 12 also includes a pair of grooves 50 formed in the first face portion 38 of the inner face 32 and another groove 52 formed in the second face portion 40 of the inner face 32 (see FIG. 3). Rings 22, 24 are each arranged to rotate in a respective groove 50 while ring 26 is arranged to rotate in groove 52.

Rings 22, 24 include projections 54, 56, respectively, which are preferably different from one another. For example, as shown, projection 54 may be longer than projection 56, i.e., extend further inward toward the central axis 14. Additionally or alternatively, projections 54, 56 may have different shapes, e.g., as shown, projection 56 is wider than projection 54. Generally, projections 54,56 may be different in form, shape, color and/or size.

Projections 54, 56 each extend outward from the respective groove 50 radially toward the central axis 14 to a position proximate or in correspondence or alignment with the indications 18. In this manner, the position of the projections 54, 56 relative to the indications 18 provides a reading of the physical quantity being (determined or measured and) displayed by the apparatus 10. For example, in the illustrated embodiment where the apparatus 10 is used to display time, the set 16 of indications 18 includes numbers 3, 6, 9 and 12 and intermediate markings in a conventional manner so that the position of the projections 54, 56 (one of which will be equivalent to the minute hand of a conventional analog watch and the other of which will be equivalent to the hour hand) enables the time to be obtained.

The illustrated embodiment also includes a seconds hand, i.e., ring 26 includes a projection 58 which extends outward from groove 52 toward the central axis 14 to a position proximate or in correspondence or alignment with a second set 60 of indications 62 formed on the intermediate face 36 of the frame 12 (inward of the first set 16 of indications 18). The set 60 of indications 62 is formed above the ring 26 and projection 58.

Although in the illustrated embodiment, the projections 54, 56, 58 extend radially inward toward the central axis 14, it is conceivable that one or more of the projections 54, 56, 58 extend in a different direction, i.e., not radially inward toward the central axis 14. For example, the projections 54, 56, 58 could extend inward at a non-radial angle yet still be positionable proximate, in correspondence with or in alignment with the indications 18. Also, if the rings 22, 24, 26 were spaced apart from the circumferential edge of the frame 12, then the grooves 50, 52 in which the rings 22, 24, 26 are received could be formed on an outward facing face of the frame 12 and the projections 54, 56, 58 would therefore be directed outward, e.g., radially outward. An appropriate cover to enclose the rings 22, 24, 26 would then be arranged around the frame 12.

Rotation mechanism 28 includes a plurality of drive devices 64 each extending into a respective groove 50, 52 (see FIGS. 3 and 4). Drive devices 64 can take various forms in conjunction with the form of the rings 22, 24, 26 to enable actuation of the drive device 64 to impart rotational movement to the rings 22, 24, 26. For example, the drive devices 64 can comprise a rotatable gear while each ring 22, 24, 26 includes a toothed gear 20 or surface engaging with the gear of the respective drive device 64. As such, when rotation of the gear of each drive device 64 is caused by the rotation mechanism 28, the respective ring 22, 24, 26 is rotated thereby causing movement of the projection 54, 56, 58 relative to the respective set 16, 60 of indications 18, 62. This movement is essentially periodic revolution of the projections 54, 56, 58 about the central axis 14 of the frame 12.

Rotation mechanism 28 is coupled via the drive devices 64 to a connection point on each projection 54, 56, 58 (i.e., the point at which the projections 54, 56, 58 are connected to the rings 22, 24, 26) and rotate the projections 54, 56, 58 such that the connection points are rotated in a loop around the central region of the frame 12.

Rotation mechanism 28 also includes, when the display apparatus 10 is a time piece as shown, an appropriate timing mechanism or timer micro-chip and wires to couple the timing mechanism to the drive devices 64. The wires may extend through and/or along the frame 12.

When apparatus 10 is used to display one or more measured physical quantities, such as temperature, speed, direction, pressure, altitude, vibrations, radiation or electricity, rotation mechanism 28 can include the necessary components to enable such measurement and conversion of the measurement into the proper position of the projection(s) relative to the set 16 of indications 18. In this regard, if apparatus 10 is used only to measure temperature, then only a single ring 22 would be provided on the frame 12 and the set 16 of indications 18 would correspond to a range of possible temperatures. Rotation mechanism 28 would include a temperature sensor designed to measure the temperature of the ambient atmosphere around the apparatus 10 and convert this measurement into the position in which the projection 54 on ring 22 needs to be relative to the indications 18 to cause an indication of the measured temperature to be viewable. Rotation mechanism 28 would cause the ring 22 to rotate to bring the projection 54 to the correct position, if necessary. The same concept applies to other display apparatus which include a sensor for measuring a single physical quantity.

If apparatus 10 is used to measure two different physical quantities, such as temperature and pressure, then two rings 22, 24 would be provided on the frame 12 along with two sets 16 of indications 18, one corresponding to a range of possible temperatures and the other to a range of possible pressures. The two sets of indications could be arranged concentric to one another on the intermediate face 36 of the frame 12. Rotation mechanism 28 would include a temperature sensor designed to measure the temperature of the ambient atmosphere around the apparatus 10 and convert this measurement into the position in which the projection 54 on ring 22 needs to be relative to the respective set of indications to cause an indication of the measured temperature to be viewable. Rotation mechanism 28 would also include a pressure sensor designed to measure the pressure of the ambient atmosphere around the apparatus 10 and convert this measurement into the position in which the projection 56 on ring 24 needs to be relative to the respective set of indications to cause an indication of the measured pressure to be viewable. Rotation mechanism 28 would cause the rings 22, 24 to rotate to bring the projections 54, 56 to the correct positions, if necessary. The same concept applies to other display apparatus which include two sensors for measuring two different physical quantities.

The annular frame 12 may be made of a solid material and defines a through passage 66 which may encompass the central axis 14. Thus, the central region of the apparatus 10 is not occupied by any structure necessary for use of the apparatus 10. Although frame 12 is annular as shown having a substantially circular cross-section, other shapes of the frame 12 are possible, e.g., rectangular, oval, square, hexagonal, etc. Regardless of the shape of the frame 12, it will include the open passage 66 in a central or middle region and preferably a cylindrical inner face in which one or more grooves are formed, with a ring being housed within each groove and a projection on the ring extending outward from the groove into association, correspondence or alignment with a set of indications.

Apparatus 10 preferably includes a transparent inner rim 68 coupled to the frame 12 to enclose the rings 22, 24, 26. Inner rim 68 may be made of clear glass and includes a tubular inner wall 70 defining a through, axial passage 72, an upper annular wall 74 which may be substantially contiguous with the outer face 34 of the frame 12 and a lower annular wall 76 which may be contiguous with the lower face 42 of the frame 12. Inner rim 68 may be sealed to the frame 12 to hermetically seal the rings 22, 24, 26. This would prevent intrusion of liquids and particulate matter into contact with the rings 22, 24, 26 which might adversely affect their operation.

A user interface, e.g., a setting knob 78, extends from the outer face 30 of the frame 12 and is coupled to the rotation mechanism 28 to enable the rotation mechanism 28 to be set. The knob 78 might be used to determine which physical quantity or quantities are to be displayed, and measured, and/or determine an initial position for the projections 54, 56, 58 relative to the sets 16, 60 of indications 18, 62.

Referring now to FIG. 8, in an alternative embodiment, a set 16 of indications 84 can be embodied as a screen 86, e.g., an LED or LCD screen, arranged in connection with the frame 12 which would display indications 84 such as numbers in a digital manner. In this case, the numbers 84 can change depending on the physical quantity being measured and/or displayed. Also, the display on the screen 86 could be controlled by depressing the knob 78. The screen 86 could be programmed and controlled to enable the display of multiple and different indications and backgrounds therefor, e.g., Roman numerals or Arabic numerals.

If such a screen is used, it is possible to remove the entire arrangement of rings and projections and provide just a screen 86 with an aperture or axial passage 72 in the middle, e.g., an annular screen having an interface 85 with the passage 72. Such a screen 86 could simulate both indications 84 and the movement of one or more projections or markers 81, 82, 83 over and around the indications 84. Instead of an annular screen, a circular screen without a void in the middle could also be used and display the simulation of indications arranged in a circle and movement of one or more projections or markers over and around the indications.

Apparatus 10 can be used in a variety of different ways. One way would be to mount the apparatus to a wall, in which case, a hook could be arranged on the lower face 42 of the frame 12, the cover 46 and/or the lower wall 76 of the inner rim 68. Additionally or alternatively, one or more mounting holes could be formed on the lower face 42 of the frame 12, the cover 46 and/or the lower wall 76 of the inner rim 68. To wall-mount the apparatus 10 using such mounting holes, a screw or nail would be inserted into the wall and the apparatus 10 hung onto the screw or nail via the mounting hole(s).

Apparatus 10 can also be worn in the manner of a wrist watch by attaching one end of a wristband to one side of the outer face 30 and the other end of the band to the opposite side of the outer face 30.

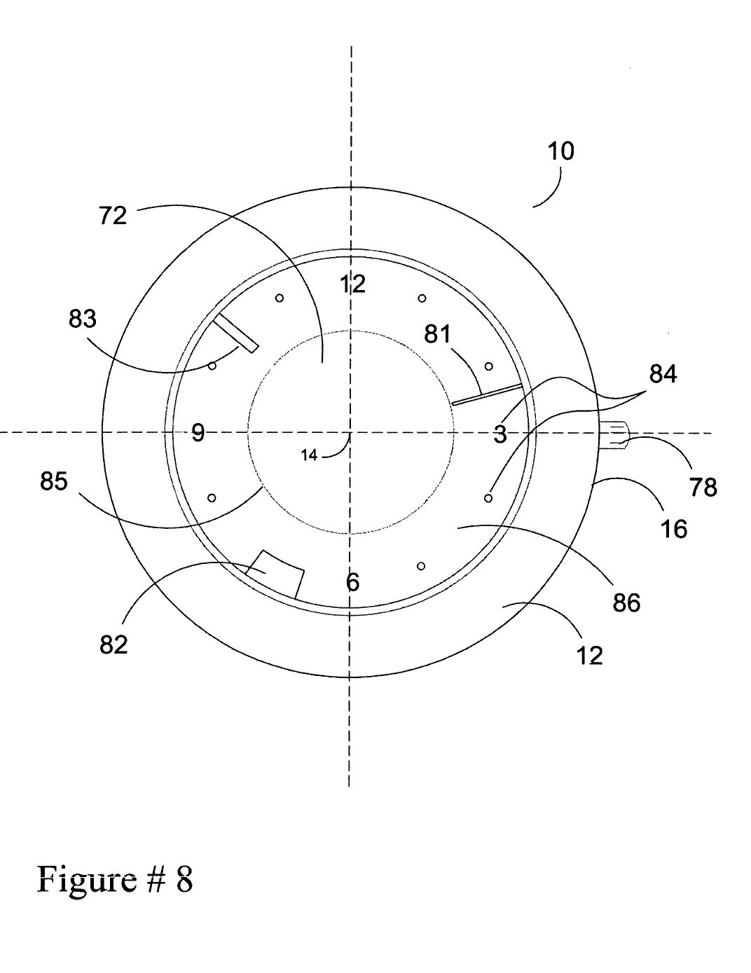

FIG. 7 shows an embodiment wherein a housing 78 is arranged in the passage 72 defined by the inner rim 68. Housing 78 can include a variety of different object and serves various different purposes. For example, housing 78 can include a display for displaying a physical quantity in a different form than displayed by cooperation of the projections 54, 56, 58 of the rings 22, 24, 26 with the indications 18, 62. In particular, when apparatus 10 is used to display time using projections 54, 56, 58 as the minute, hour and second hands, housing 78 may include a digital display device for displaying time in a digital manner. Housing 78 could alternatively include an interior storage compartment 80.

Housing 78 could also constitute or house an extra display, a personal data apparatus (PDA), an antenna for electrical signals, a sensor, a speaker, a power supply, an extra battery for the apparatus 10, a memory chip, a global positioning determining device and display, an ornamentation housing, and a medical regulator.

It is envisioned that the lower surface of the housing 78 might be designed to render time or other information through contact with human skin, e.g., when apparatus 10 is designed as a wrist watch. In this manner, information being measured and/or displayed could additionally or alternatively be transmitted to the wearer via patterns of vibrations or sensible movement generated by a device arranged in housing 78. The patterns might be in the form of numbers, letters, Braille patterns (for blind people) or any other characters.

It is also conceivable that both exposed surfaces of housing 78 are used in different manners.

An alternative embodiment of the display apparatus 10 eliminates the presence of the movable rings 22, 24, 26. Rather, instead of each movable ring, a ring in the form of an fixed endless loop of track is mounted to a surface of the frame 12. A projection is then mounted for movement along the track. If the tracks are mounted or formed on an inwardly facing surface of the frame 12, then the projections could be directed inward while if the tracks are mounted or formed on an outwardly facing surface of the frame 12, then the projections could be directed outward. Movement of each projection along the respective track can be achieved using any known technologies, e.g., an electrical, magnetic or mechanical movement system.

With any of the constructions of the apparatus 10 described above, there are no hands which revolve around a central, fixed axis. As such, the need for complicated rotary mechanisms to rotate pins associated with multiple indicator hands is avoided.

While particular embodiments of the invention have been shown and described, it will be obvious to those skilled in the art that changes and modifications may be made without departing from the invention in its broader aspects, and, therefore, the aim in the appended claims is to cover all such changes and modifications as fall within the true spirit and scope of the invention. For example, although the rings are described as separate components from the rotation mechanism, the rings can be part of the rotation mechanism.

1. A display apparatus comprising:
a frame defining a central region;
at least one set of indications arranged on said frame around said central region;
at least one projection arranged proximate, in correspondence with or in alignment with one of said at least one set of indications; and
a rotation mechanism coupled to a connection point on each of said at least one projection to rotate said projection such that said connection point is rotated in a loop around said central region, said rotation mechanism being arranged to determine a quantity to be displayed and control rotation of said at least one projection based thereon.

2. The display apparatus of claim 1, further comprising at least one ring mounted on said frame, each of said at least one projection extending away from and being associated with a respective one of said at least one ring, said connection point on each of said at least one projection being a point at which said projection is connected to the respective one of said at least one ring.

3. The display apparatus of claim 2, wherein said at least one ring is rotatable relative to said frame.

4. The display apparatus of claim 2, wherein said at least one ring comprises first and second rings, said projection associated with said first ring being different than said projection associated with said second ring.

5. The display apparatus of claim 4, wherein said frame has a central axis, said projection associated with said first ring extends further inward toward said central axis than said projection associated with said second ring.

6. The display apparatus of claim 4, wherein said projection associated with each of said at least one ring overlies said indications.

7. The display apparatus of claim 2, wherein said at least one set of indications comprises first and second sets of indications, said at least one ring comprising first, second and third rings, said projections associated with said first and second rings being arranged to overlie said first set of indications and said projection associated with said third ring being arranged below said second set of indications.

8. The display apparatus of claim 2, wherein said frame includes a substantially cylindrical inner face facing a central axis and at least one groove formed in said inner face, each of said at least one ring being arranged in a respective one of said at least one groove, said projection associated with each of said at least one ring extending outward from the respective one of said at least one groove toward said central axis.

9. The display apparatus of claim 8, wherein said rotation mechanism comprises at least one drive device arranged on said frame and extending into a respective one of said at least one groove.

10. The display apparatus of claim 9, wherein said at least one drive device comprises a rotatable gear and said at least one ring includes a toothed surface engaging with a respective one of said at least one drive device such that upon rotation of said gear, said at least one ring rotates.

11. The display apparatus of claim 1, wherein said at least one ring comprises first and second rings, said projections on said first and second rings being arranged proximate, in correspondence with or in alignment with a common one of said at least one set of indications.

12. The display apparatus of claim 1, further comprising a transparent inner rim arranged in a central passage defined by said frame and coupled to said frame to enclose said at least one projection.

13. The display apparatus of claim 12, wherein said inner rim defines an axial passage, further comprising a housing arranged in said axial passage.

14. The display apparatus of claim 13, wherein said housing includes a display for displaying a physical quantity in a different form than displayed by cooperation of said at least one projection and said at least one set of indications.

15. The display apparatus of claim 13, wherein said housing includes an interior storage compartment.

16. The display apparatus of claim 12, wherein said inner rim defines an axial passage, further comprising a mechanical, electrical, chemical or organic attachment arranged in said axial passage.

17. The display apparatus of claim 1, wherein said frame defines a chamber on a lower side and said indications are arranged to face upward, said mechanism being at least partially arranged in said chamber, further comprising a cover arranged on said frame to enclose said chamber.

18. The display apparatus of claim 1, wherein said frame is annular and defines a void encompassing a central axis.

19. A display apparatus comprising:
a frame defining an interior space;
a screen arranged in said interior space; and
measuring and display means arranged in connection with said frame and coupled to said screen for determining at least one physical quantity to be displayed on said screen and directing said screen to display a set of indications in a fixed position relating to said at least one physical quantity and at least one projection arranged to move relative to said indications, said measuring and display means being arranged to cause said at least one projection to move relative to said indications as at least one physical quantity changes.

20. The display apparatus of claim 19, wherein said screen is annular, said indications being numbers and said at least one projection being a plurality of projections enabling said screen to be used to display time.
